(19) United States
(12) Patent Application Publication
(10) Pub. No.: US 2007/0206279 A1
(43) Pub. Date: Sep. 6, 2007

(54) DEVICE FOR INSPECTING A MICROSCOPIC COMPONENT BY MEANS OF AN IMMERSION OBJECTIVE

(75) Inventors: Hans-Juergen Brueck, Muenchen (DE); Frank Hillmann, Deggendorf (DE); Gerd Scheuring, Muenchen (DE); Hans-Artur Boesser, Breidenbach (DE)

Correspondence Address: HOUSTON ELISEEVA, 4 MILITIA DRIVE, SUITE 4, LEXINGTON, MA, 02421, US

(73) Assignee: VISTEC SEMICONDUCTOR SYSTEMS GMBH, Wetzlar (DE)

(21) Appl. No.: 11/569,180

(22) PCT Filed: Jul. 5, 2005
(86) PCT No.: PCT/EP05/53213

§ 371 Date: Nov. 16, 2006

(30) Foreign Application Priority Data
Jul. 9, 2004 (DE) 10 2004 033 208.8

(51) Int. Cl. G02B 21/26

(52) U.S. Cl. 359/391

(57) ABSTRACT

A device (1) is disclosed for inspecting, measuring defined structures, simulating structures and structural defects, repair of and to structures, and post-inspecting defined object sites on a microscopic component (2) with an immersion objective (8a). The device (1) comprises a stage that is movable in the x-coordinate direction and in the y-coordinate direction and a holder (42) for the microscopic component (2), whereby the holder (42) is placed on the stage (4) with the microscopic component (2) in it. The holder (42) has a reservoir (51a) with immersion or cleaning fluid, respectively. The stage (4) is movable such that the immersion objective (8a) is located directly above the reservoir (51a) and may dip into the fluid with its front-most lens.

### RELATED APPLICATIONS

This application is a National Stage application of PCT application serial number PCT/EP2005/053213 filed on Jul. 5, 2005, which in turn claims priority to German application serial number 10 2004 033 208.8 filed on Jul. 9, 2004.

### FIELD OF THE INVENTION

The invention relates to a device for inspecting a microscopic component by means of an immersion objective. In particular, the invention relates to a device for inspecting, measuring defined structures, simulation of structures and structural defects, repair of and to structures, and post-inspection of defined object places of a microscopic component by means of an immersion objective. The device comprises a stage that is movable in the x-coordinate direction and in the y-coordinate direction and a holder for the microscopic component, whereby the holder with the microscopic component that it holds is placed on the stage.

### BACKGROUND OF THE INVENTION

German patent application 101 23 027.3 A1 discloses a device for inspecting chemical and/or biological samples. The samples are placed in a receptacle device that has a transparent bottom. Inspection of the samples is performed through the bottom. A gap is formed between the bottom and the objective. An automatic feed device is provided that introduces an immersion medium between the outer surface of the front-most lens of the objective and the bottom of the receptacle device.

German utility model 80 12 550.4 discloses an ocular microscope. To avoid reflections and to achieve higher resolution, the front-most lens is in touch with the cornea. An appropriate adapter ensures that the fluid layer is maintained at a certain thickness.

German patent application DE 31 222 408 A1 discloses a device and a system for cleaning and wetting the front surface of an ultrasound objective. For this purpose a nozzle is provided, which is directed onto the front surface of the lens, and through which cleaning and/or wetting fluid is forced through the nozzle opening.

In none of these devices known from the state of the art is it suggested that a park or wetting position be used for an immersion objective.

### SUMMARY OF THE INVENTION

The object of the present invention is therefore to increase the resolution of an inspection device by using an immersion objective. For this purpose, the required application and removal of immersion fluid is to be automated. It is further to be ensured that no residue adheres to the front-most lens of the immersion objective.

According to the invention, this object is solved by an inspection device with the characteristics in claim 1.

It is of advantage for the holder for the microscopic component to have a reservoir with immersion fluid and cleaning fluid formed at a site, and that the stage be movable such that the immersion objective is located above the reservoir, such that the front-most lens of the objective may dip into the immersion fluid or the cleaning fluid. The reservoir is formed in the holder as a depression, and the depression is coated with a hydrophobic layer that exhibits negligible solubility relative to the immersion fluid and the cleaning fluid. The hydrophobic layer may, for example, comprise PTFE.

The small quantity of fluid is a drop of fluid that represents the immersion fluid. Highly purified water is recommended as the immersion fluid for a number of applications. The device may also be operated with other immersion fluids that are described in the literature. When cleaning the objective, the fluid drop is a cleaning fluid.

Likewise, a cleaning device is provided that is arranged such that it may be retracted and extended in the inside of the suction device, and wherein a nozzle tip of the cleaning device can penetrate the fluid quantity between the immersion objective 8a and the surface 2a of the microscopic component. It is particularly advantageous if in the case of a raised immersion objective, the nozzle tip of the cleaning device penetrates a fluid bridge formed between the surface of the microscopic component and a front-most lens of the immersion objective and destroys the fluid bridge and/or suctions a portion of the fluid. The nozzle tip of the cleaning device may be introduced into the area around the front-most lens of the immersion objective in order to remove residual adherent fluid drops.

In order to achieve high resolution, a portion of the light for inspecting with an immersion objective should have a wavelength of 248 nm or shorter such as 193 nm. The several objectives may be mounted to a turret. Likewise, a fixed arrangement of two or several objects to each other is also conceivable, whereby one objective is the immersion objective, and the other(s) is/are used for alignment and other inspectional tasks using visible light.

The device for suctioning a small quantity of fluid is provided with a multiplicity of suction nozzles on the surface of the opposite side of the microscopic component. The suction nozzles comprise an edge and a suction channel, whereby the edge is at a controlled distance of less than 300 μm from the surface of the microscopic component. In the embodiment represented here, the device has for the purpose of suctioning a prominence on the side that is opposite the surface of the microscopic component, on which the suction nozzles are arranged such that the individual suction nozzles jut out over the prominence. The prominence is implemented in the present embodiment. The prominence on which the elevated suction nozzles are arranged is not necessary for functionality.

Further advantages and advantageous embodiments of the invention are the subject of the following figures and their descriptions.

### BRIEF DESCRIPTION OF THE DRAWINGS

The object of the invention is schematically represented in the diagram and is described on the basis of the figures below. They show:

FIG. 1—a schematic design of the device for inspecting and/or measuring, simulating, and repairing a microscopic component;

FIG. 2—a schematic view of an immersion objective in the working position;

FIG. 3—a schematic representation of an embodiment of the suction device;

FIG. 4—a bottom view of a device for inspecting a microscopic component, whereby the area around the suction device is represented;

FIG. 5—a detailed perspective view of the area around the objective and the microscopic component;

FIG. 6—a schematic view of the immersion objective in the working position;

FIG. 7—a schematic view of the immersion objective, slightly moved out of the working position;

FIG. 8—a schematic view in which the fluid bridge between the front-most lens of the immersion objective and the surface of the microscopic component has been broken up;

FIG. 9—a schematic representation of a holder for the microscopic component;

FIG. 10—a schematic representation of a further embodiment of the holder for the microscopic component;

FIG. 11—a perspective top view of an embodiment of the device for suctioning small quantities of fluid; and

FIG. 12—a perspective bottom view of an embodiment of the device for suctioning small quantities of fluid.

### DETAILED DESCRIPTION OF THE PREFERRED EMBODIMENTS

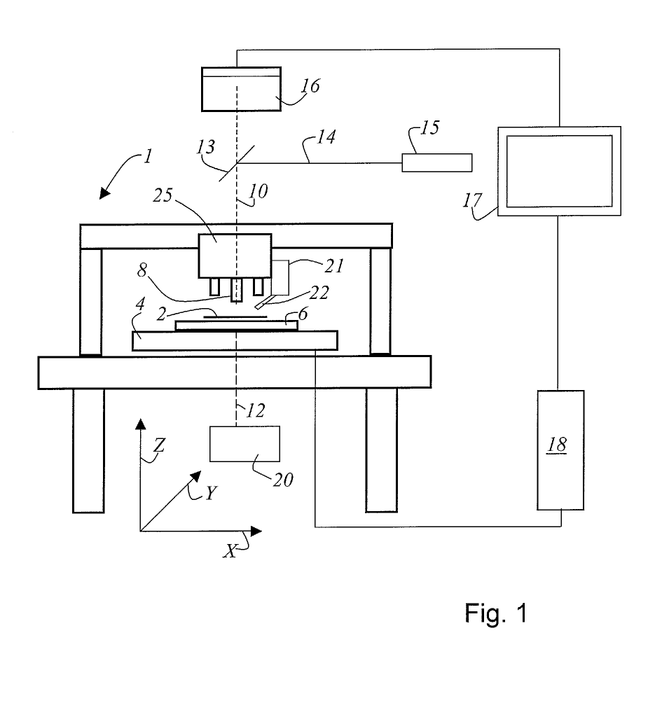

FIG. 1 shows a schematic design of a device 1 for inspecting, measuring defined structures, simulating structures and structural defects, repair of and to structures, and post-inspection of defined object sites of a microscopic component. A stage 4 that is implemented as a scanning table is provided for the microscopic component 2 on the basic frame 3. The stage 4 is movable in an x-coordinate direction and in a y-coordinate direction. The microscopic component 2 to be inspected is placed on the stage 4. The microscopic component 2 may be held on the stage 4 in a supplemental holder 6. The microscopic component 2 is a wafer, a mask, several micromechanical components on a substrate, or a component of related type. At least one objective 8, which defines an imaging beam path 10, is provided for imaging the microscopic component 2. The stage 4 and the additional holder 6 are implemented such that they are suitable both for incident light illumination and also for transmitted light illumination. For this purpose, the stage 4 and the additional holder 6 are implemented with a recess (not depicted) for passage of an illumination light path 12. The illumination light path 12 exits from a light source 20. A beam splitter 13 that couples or outcouples an auxiliary beam for focusing 14 is provided in the imaging beam path 10. The focal position of the microscopic component is determined or measured, as the case may be, by a detection unit 15. A CCD camera 16 is provided behind the beam splitter 13 in the imaging beam path 10, with which the image of the site on the microscopic component 2 that is to be inspected can be recorded or imaged. The CCD camera 16 is connected to a monitor 17 and a computer 18. The computer 18 serves to control the device 1 for inspecting, for processing the image data that have been captured, and for storing the pertinent data. Likewise, the computer 18 also serves to control the application and suctioning of immersion fluid. In the embodiment of the invention represented here, several objectives 8 on a turret 25 are provided such that a user may select various enlargements. System automation is achieved using the computer 18. In particular, the computer serves to control the stage 4, to read out the CCD camera 16, to apply a small quantity of fluid to the microscopic component 2, and to drive the monitor 17. The stage 4 is movable in an x-coordinate direction and a y-coordinate direction; the x-coordinate direction and a y-coordinate direction are perpendicular to each other. In this manner, each site on the microscopic component 2 that is to be inspected may be introduced into the imaging beam path 10. The device 1 for inspecting a microscopic component 2 further comprises a device 21 for applying a small quantity of fluid to the microscopic component 2. A nozzle 22 is provided to apply the small quantity of fluid, and may be moved in an appropriate manner to precisely the site where the small quantity of fluid is to be applied. It is also conceivable for the device to be provided with two objectives that are firmly arranged in relation to each other, of which one objective is an immersion objective 8a for DUV (248 nm or shorter, e.g., 193 nm). The other objective may, for example be an objective for visible light that can be used for alignment or other inspectional tasks.

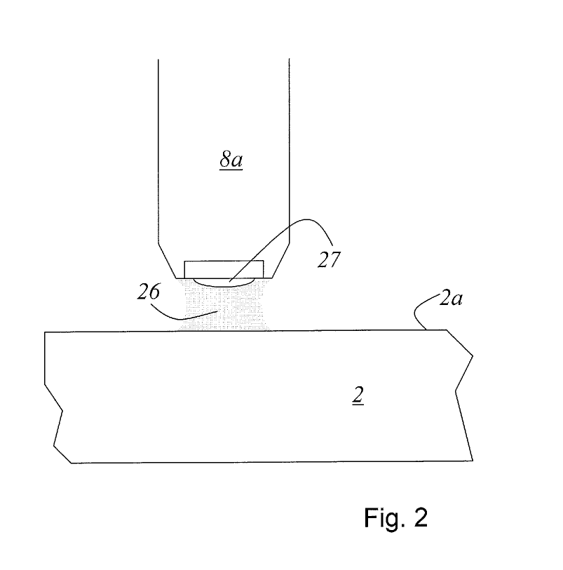

FIG. 2 shows a schematic view of an immersion objective 8a in the working position. A small quantity of fluid 26 is introduced between the immersion objective 8a and the surface 2a of the microscopic component 2. The small quantity of fluid 26 wets the front-most lens 27 of the immersion objective 8a as well as the surface of the microscopic component 2 to be inspected.

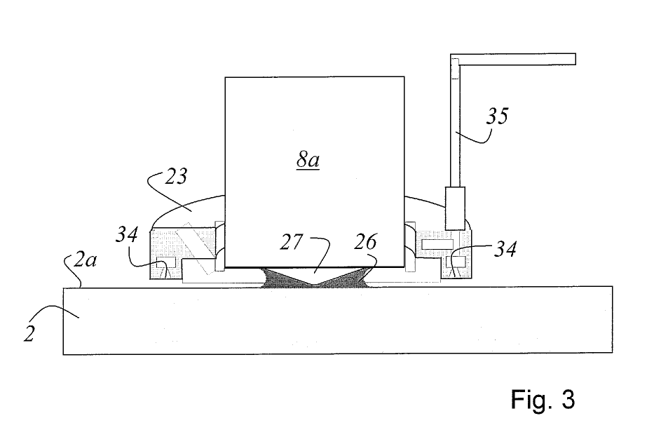

FIG. 3 is a schematic representation of the embodiment of a device for suctioning small quantities of fluid 26 from the surface 2a of a microscopic component. The immersion objective 8a is arranged opposite the surface 2a of the microscopic component 2. A small quantity of fluid 26 is applied between the front-most lens 27 of the immersion objective 8a and the surface 2a of the microscopic component 2. The immersion objective 8a is surrounded in this embodiment by the suction device 23. The suction device 23 is implemented with several openings 34 on a side 32 that is opposite the surface 2a of the microscopic component 2. The fluid from the surface 2a of the microscopic component 2 may be suctioned off as needed through these openings 34. The suction device 23 is connected to a negative pressure reservoir (not depicted) via a tubing 35. The fluid is suctioned from the surface 2a by applying negative pressure. In a further embodiment, it is conceivable to replace suctioning by negative pressure by proximity to a material with strong capillary action (such as a sponge).

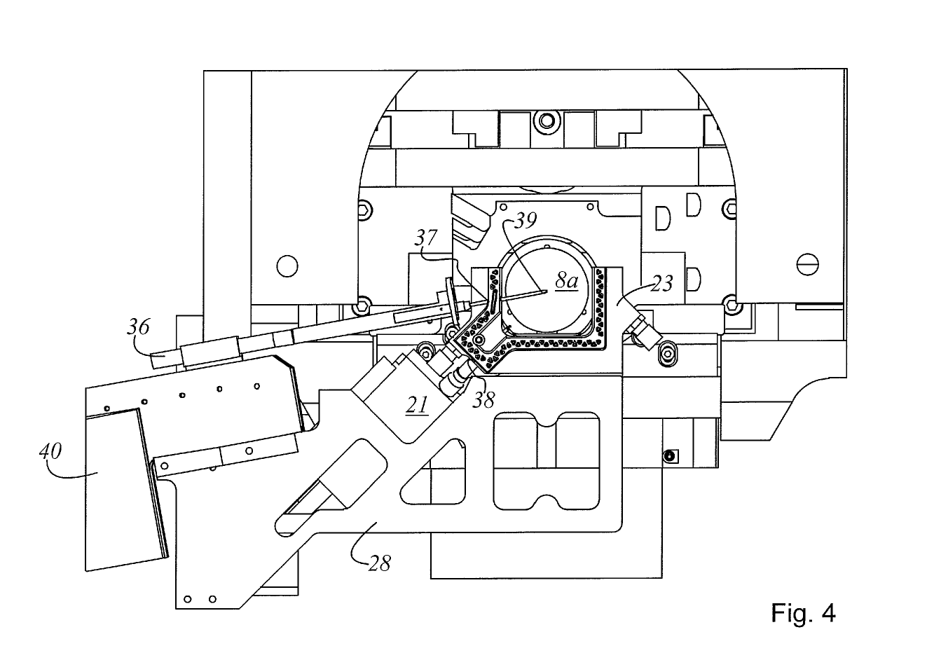

FIG. 4 shows a bottom view of the device for inspecting a microscopic component 2, whereby the area around the suction device 23 is represented. The suction device 23 is allocated to the immersion objective 8a. In the embodiment represented here, the suction device 23 is implemented in a U-shape. Although the following description is limited to a U-shaped suction device 23, this should not be interpreted as a limitation of the invention. The suction device 23 is mounted to a carrier 28. The carrier 28 is movably implemented such that the suction device 23 may be moved out of the area of linear or pivoting movement of the objective 8a. Furthermore, a device 21 for applying a small quantity of fluid and a cleaning device 36 are provided on the carrier 8a. The cleaning device 36 serves to remove reliably from the objective 8a any fluid that still adheres to it. Furthermore, the cleaning device 36 is also suitable for breaking up a fluid bridge 29 that forms when lifting the immersion objective 8a. The application device 21 and the cleaning device 36 are positioned in the area around the immersion objective 8a by corresponding recesses 37 and 38 in the suction device 23. The cleaning device 36 comprises a nozzle tip 39 with which residual fluid that adheres to the immersion objective 8a may be reliably suctioned off. It is also conceivable that the objective may be freed of fluid by a targeted pulse-like stream of gas—with a corresponding receptacle device for the fluid and a protective device to prevent contamination of the microscopic component.

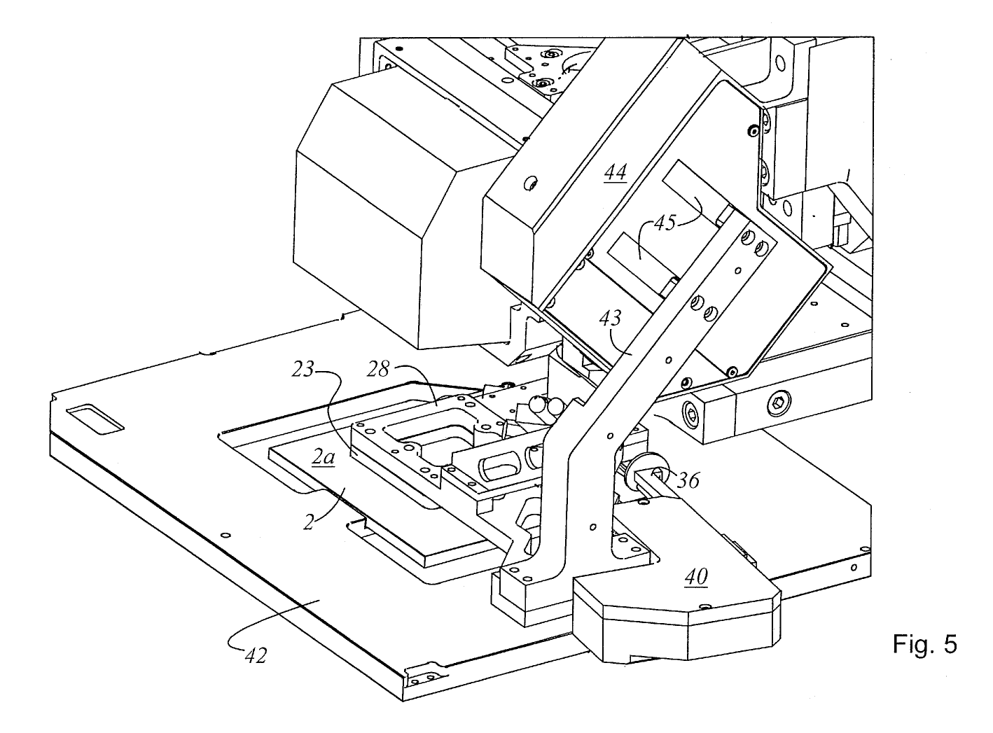

FIG. 5 shows a detailed perspective view of the area around the immersion objective 8a, and the microscopic component 2. The device 21 for applying a small quantity of fluid to the microscopic component 2 and the cleaning device 36 are attached to the mimic 40, which is movably implemented. The device 23 for suctioning small quantities of fluid is from the surface 2a of the microscopic component 2 is attached to the carrier 28. The device 23 for suctioning small quantities of fluid is provided in the working position directly opposite the surface 2a of the microscopic component 2. In the embodiment represented in FIG. 5, the microscopic component 2 is a mask for producing semiconductors. Here, the mask is positioned in a separate mask holder 42. The carrier 28 is mounted via a rigid arm 43 to a lifting device 44, which lifts the carrier 28 together with the suction device 23 from the surface 2a of the microscopic component 2. The arm 43 on the lifting device 44 is movable for the purpose in the direction of two elongated holes 45.

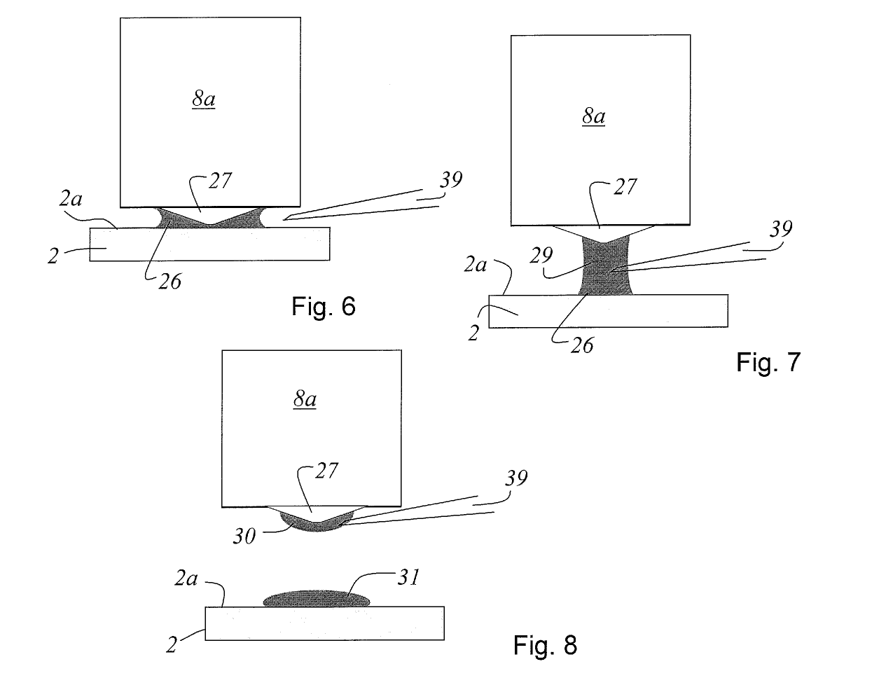

FIG. 6 shows the immersion objective 8a in the working position. A small quantity of fluid 26 is introduced between the front-most lens 27 of the immersion objective 8a and the surface 2a of the microscopic component 2. Likewise, the nozzle tip 39 of the cleaning device 36 is allocated to the immersion objective 8a. FIG. 7 illustrates the circumstance in which the immersion objective 8a is somewhat elevated and therefore moved out of the working position. The quantity of fluid 26 (see FIG. 6) that is present between the front-most lens 27 of the immersion objective 8a and the surface 2a of the microscopic component 2 is deformed into a fluid bridge 29. The nozzle tip 39 of the cleaning device 36 penetrates the fluid bridge 29 in order to interrupt it by suctioning. FIG. 8 illustrates the circumstance in which the fluid bridge 29 has already been broken up. Nevertheless, a quantity of fluid remains on the surface 2a of the microscopic component 2, and residual fluid continues to adhere to the front-most lens 27 of the immersion objective 8a. The nozzle tip 39 of the cleaning device 36 is moved to the front-most lens 27 of the immersion objective 8a in order to remove the fluid 30 that adheres to it. The residual fluid 31 that is still present on the surface 2a of the microscopic component 2 is removed by the suction device 23. It is particularly important that the fluid on the front-most lens 27 of the immersion objective 8a not evaporate because evaporation residue might then form on it, which may negatively affect the imaging quality of the immersion objective 8a.

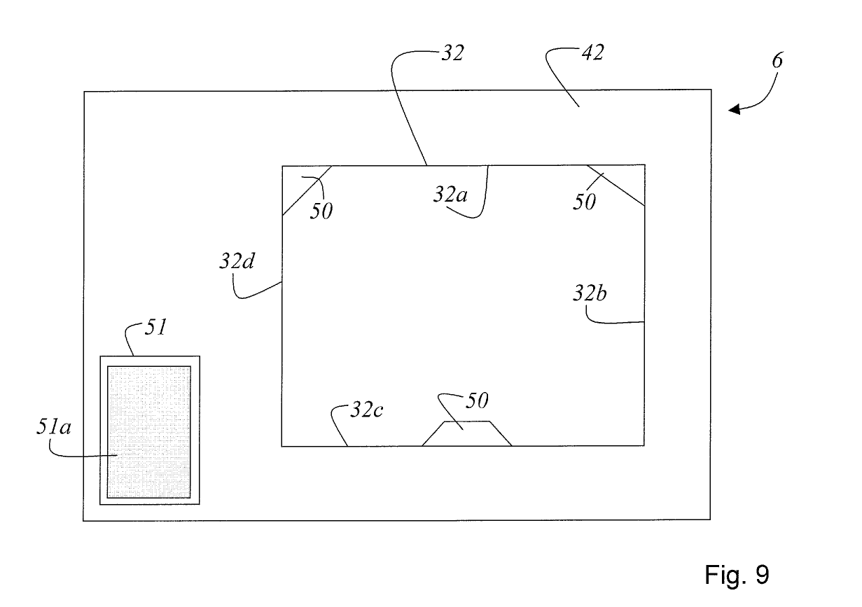

FIG. 9 is a schematic representation of a holder 6 for the microscopic component 2. In the embodiment represented here, the holder 6 is implemented as a mask holder 42. The mask holder 42 is generally rectangular and has a formed opening 32 into which is placed the mask to be held. The opening 32 is formed of a first side 32a, a second side 32b, a third side 32c, and a fourth side 32d along with the edge 34 of the opening 32. At least three bearing points 50 are formed on the edge 34 of the opening, onto which the mask to be inspected is placed. Furthermore, the mask holder 42 has a park position 51 comprised of a hydrophobic layer with negligible solubility (e.g., PTFE), in which the immersion objective 8a is positioned during pauses in measurement. Furthermore, the front-most lens 27 of the immersion objective 8a may be wetted with immersion fluid in the park position 51. Wetting has the advantage that some fluid already adheres to the front-most lens 27 of the immersion objective 8a, which is then merged with the small quantity of fluid applied by the device 21. This is of particular advantage in the case of hydrophilic surfaces of the objects to be inspected because the applied fluid would otherwise run off such that a layer of fluid of inadequate thickness might be formed under certain circumstances. The fluid applied to the surface 2a merges with the fluid that already adheres to the front-most lens 27 of the immersion objective 8a such that an adequate quantity of immersion fluid is present. A reservoir 51a which contains fluid is formed in the park position 51. The immersion objective 8a dips with the front-most lens 27 into this fluid. In the process, evaporation of the residual fluid that adheres to the front-most lens 27 of the immersion objective 8a is prevented, and in addition, the front-most lens 27 of the immersion objective 8a is wetted in the park position 51. The stage 4, which is movable in the x-coordinate direction and in the y-coordinate direction is moved accordingly such that the park position 51 is located below the immersion objective 8a.

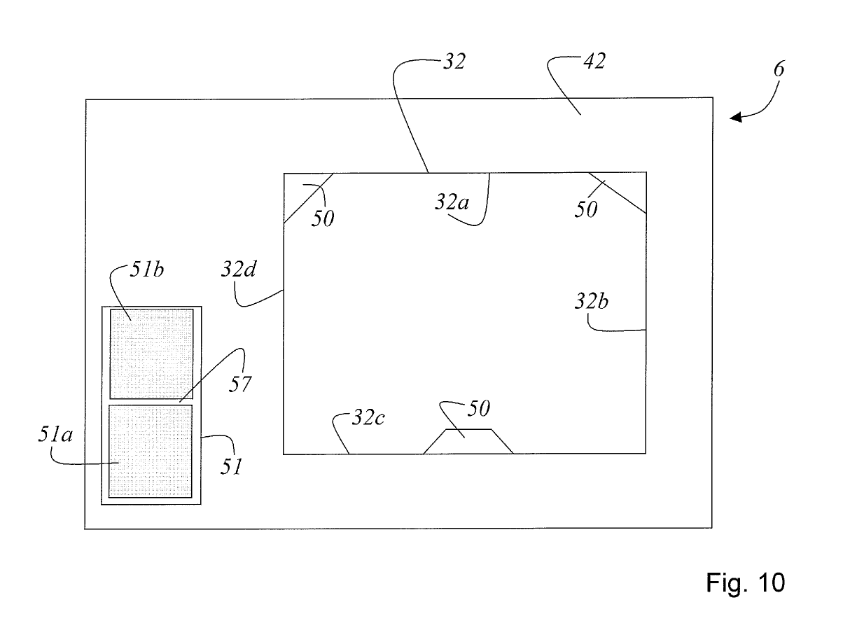

FIG. 10 is a schematic representation of a further embodiment of the holder 6 for the microscopic component 2. The mask holder 42 is implemented with a park position 51 that has a hydrophobic layer with negligible solubility (e.g. PTFE), in which the immersion objective 8a is positioned during pauses in measurement. A first reservoir 51a and a second reservoir 51b are formed at the park position 51 by a separating wall 57. Immersion fluid may be present in the first reservoir 51a and cleaning fluid in the second reservoir 51b. The immersion objective 8a dips into the immersion fluid or cleaning fluid with the front-most lens 27.

The immersion fluid or the cleaning fluid is replaced at regular intervals during periods of longer dwell time of the objective in the park position, by which complete evaporation and increasing contamination by concentration of foreign matter may be prevented. The suction device 23 is used to remove fluid in the embodiment of the invention depicted here. This is the device that also removes fluid from the surface of the microscopic component. However, a separate device is also conceivable.

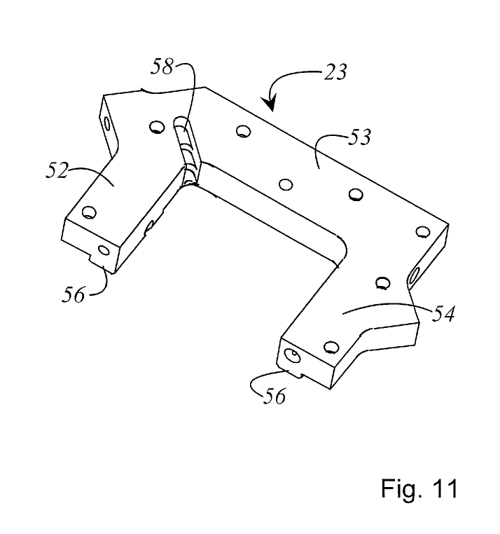

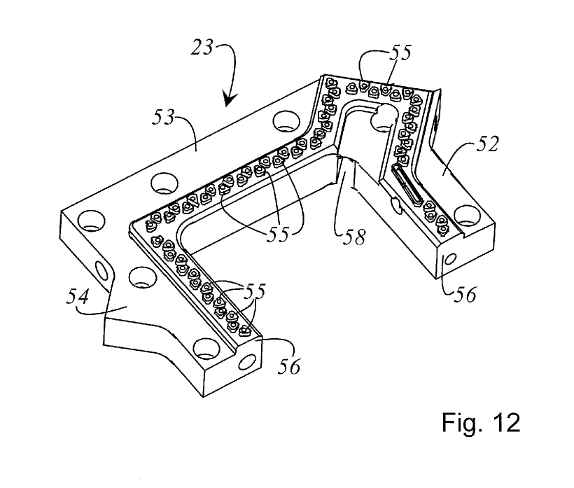

FIG. 11 is a perspective top view of an embodiment of the device 23 for suctioning small quantities of fluid. The suction device 23 in this embodiment is implemented in a U-shape and comprises a first leg 52, a second leg 53, and a third leg 54. The suction device 23 exhibits a prominence 56 on the side opposite the microscopic component 2, in which the suction nozzles 55 are formed (see FIG. 12. The suction device 23 further exhibits a countersink 58 that is supplied by the nozzle tip 39 of the cleaning device 36.

FIG. 12 is a perspective bottom view of an embodiment of the device 23 for suctioning small quantities of fluid. The prominence 56 is implemented as a continuous band along the first, second, and third legs 52, 53, and 54. The prominence bears a multiplicity of suction nozzles 55 which, in the working position of the suction device 23, lie opposite to the surface 2a of the microscopic component 2.

What is claimed is:

1. Device (1) for inspecting a microscopic component (2) with an immersion objective (8a). The device (1) comprises a stage (4) in the x-coordinate direction and in the y-coordinate direction and a holder (42) for the microscopic component (2), whereby the holder (42) that holds the microscopic component (2) is placed on the stage (4), wherein an immersion fluid is introduced between the front-most lens (27) of the immersion objective (8a) and a surface (2a) of the microscopic component (2), wherein the holder (42) has formed a reservoir (51a) with immersion fluid at a site, and wherein the stage (4) is movable such that the immersion objective (8a) is located at the site of the reservoir (51a) and dips into the fluid present in the reservoir (51a).

2. Device (1) according to claim 1, wherein the reservoir (51a) is formed as a depression in the holder (42), and wherein the depression is coated with a hydrophobic layer.

3. Device (1) according to claim 1, wherein the hydrophobic layer consists of Teflon.

4. Device according to claim 1, wherein the microscopic component (2) is a mask, on the surface (2a) of which structures are formed.

5. Device according to claim 1, wherein the microscopic component (2) is a wafer that has a surface (2a) on which structures are formed.

6. Device according to claim 1, wherein the microscopic component (2) is a substrate that carries, among other things, a multiplicity of micromechanical elements on a surface (2a)

7. Device according to claim 1, wherein the small quantity of fluid (26) is a drop of fluid that represents the immersion fluid, wherein the immersion fluid is water, and wherein the immersion objective (8a) is a water immersion objective.

8. Device according to claim 7, wherein a portion of the light for inspecting with the immersion objective (8a) has a wavelength of 248 nm.

9. Device according to claim 1, wherein a device (21) for applying a small dosed quantity of fluid to the surface (2a) of the microscopic component (2), and wherein a device (23) for suctioning the small quantity of fluid over the surface (2a) of the microscopic component (2) are mounted, whereby the suction device (23) at least partially surrounds the immersion objective (8a).

10. Device according to claim 1, wherein a cleaning device (36) is provided that is arranged such that it may be extended and retracted into the inside of the suction device (23), and wherein a nozzle tip (39) of the cleaning device (36) penetrates the quantity of fluid between the immersion objective (8a) and the surface (2a) of the microscopic component (2).

11. Device according to claim 10, wherein in the case of a raised immersion objective (8a), the nozzle tip (39) of the cleaning device (36) penetrates a fluid bridge (29) formed between the surface (2a) of the microscopic component (2) and a front-most lens (27) of the immersion objective (8a) and breaks up the fluid bridge (29) and/or suctions a portion of the fluid.

12. Device according to claim 11, wherein the nozzle tip (39) of the cleaning device (36) is movable in the area around the front-most lens (27) of the immersion objective (8a) in order to remove any residually adherent drop of fluid (30).

13. Device according to claim 1, wherein the device (23) for suctioning the small quantity of fluid on the surface (2a) of the microscopic component (2) is provided with a multiplicity of suction nozzles (55) on the opposite side.

14. Device according to claim 13, wherein the suction nozzles (55) are at a distance (62) of 100 μm to 300 μm from the surface (2a) of the microscopic component (2).
